(19) United States
(12) Patent Application Publication
(10) Pub. No.: US 2006/0262033 A1
(43) Pub. Date: Nov. 23, 2006

(54) Display for vehicle

(75) Inventors: Te-Yang Shen, Taoyuan Hsien (TW); Chien-Chia Lin, Taoyuan Hsien (TW); Chia-Jung Chang, Taoyuan Hsien (TW); Ming Yeh, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/375,104

(22) Filed: Mar. 15, 2006

(30) Foreign Application Priority Data
May 19, 2005 (TW) 094116206

(51) Int. Cl. G09G 5/00

(52) U.S. Cl. 345/1.1

(57) ABSTRACT

A display for a vehicle includes a flat panel and an angle-adjusting mechanism which is connected to the flat panel for flexibly adjusting an angle of the flat panel. The angle-adjusting mechanism includes a first active element and a first driver. The first active element is connected to the flat panel, and the first driver is connected to the first active element so as to drive the first active element to adjust the angle of the flat panel. The first active element connected to a central region of the flat panel for providing a moving force onto the flat panel, and the first active element is moved forward to push the flat panel or moved backward to pull the flat panel.

This Non-provisional application claims priority under U.S.C.§ 119(a) on Patent Application No(s). 094116206, filed in Taiwan, Republic of China on May 19, 2005, the entire contents of which are hereby incorporated by reference.

### BACKGROUND OF THE INVENTION

1. Field of Invention

The present invention relates to a display for a vehicle and in particular to an angle-adjustable display for a vehicle.

2. Related Art

In view of rapid development of technology, there are more and more modern audio and video electronic products applied into vehicle. People may not only watch movies via video compact disc (VCD) and digital video disc (DVD) but also watch TV program via wireless technology when they are in a vehicle.

Generally, a liquid crystal display (LCD) is applied for saving space in a car and the LCD may be installed in a central control platform way, seat-back way or roof-mount way.

However, the viewing angle of LCD is still limited no matter what kinds of installation ways are used. Due to this limitation, the images of the LCD could not be clearly viewed by all passengers in different angles.

It is therefore an important subject of the present invention to provide an angle-adjustable display for a vehicle to solve above-mentioned problems and allow the images of the display to be clearly viewed in different angles.

### SUMMARY OF THE INVENTION

In view of the foregoing, the present invention is to provide an angle-adjustable display for a vehicle for being clearly viewed by passengers.

To achieve the above, a display for a vehicle according to the present invention includes a flat panel, a holding element and a first active element. The holding element has a rotatable portion. The holding element and the first active element are connected to the flat panel. The first active element is moved forward to push the flat panel or the first active element is moved backward to pull the flat panel. Further, the display has a first driver connected to the first active element so as to drive the first active element to allow the flat panel to rotate with respect to the rotatable portion of the holding element and adjust an angle of the flat panel.

To achieve the above, another display for a vehicle according to the present invention includes a flat panel and an angle-adjusting mechanism. The angle-adjusting mechanism is connected to the flat panel for flexibly adjusting an angle of the flat panel. The angle-adjusting mechanism includes a first active element and a first driver. The first active element is connected to the flat panel, and the first driver is connected to the first active element so as to drive the first active element to adjust the angle of the flat panel. The first active element is connected to a central region of the flat panel for providing a moving force onto the flat panel, and the first active element is moved forward to push the flat panel or the first active element is moved backward to pull the flat panel.

As mentioned above, because the display for a vehicle uses a holding element and a first active element connected to flat panel, the first active element provides a moving force onto the flat panel. By disposing the first active element near a right or left edge of the flat panel, and disposing the second active element near a top or bottom edge of the flat panel, the flat panel can be pushed or pulled in accordance with practical requirements. As the result, the angle of the flat panel is flexibly adjusted and the display can be clearly viewed.

### BRIEF DESCRIPTION OF THE DRAWINGS

The present invention will become more fully understood from the detailed description given herein below illustration only, and thus is not limitative of the present invention, and wherein:

FIG. 1 is a schematic view showing a display for a vehicle according to a preferred embodiment of the present invention;

FIGS. 2A and 2B are schematic views showing that the angle of the flat panel in FIG. 1 is adjusted;

FIG. 3 is an exploded schematic view showing the display in FIG. 1; and

FIGS. 4A to 4C are schematic views showing the operation of the display in FIG. 1.

### DETAILED DESCRIPTION OF THE INVENTION

The present invention will be apparent from the following detailed description, which proceeds with reference to the accompanying drawings, wherein the same references relate to the same elements.

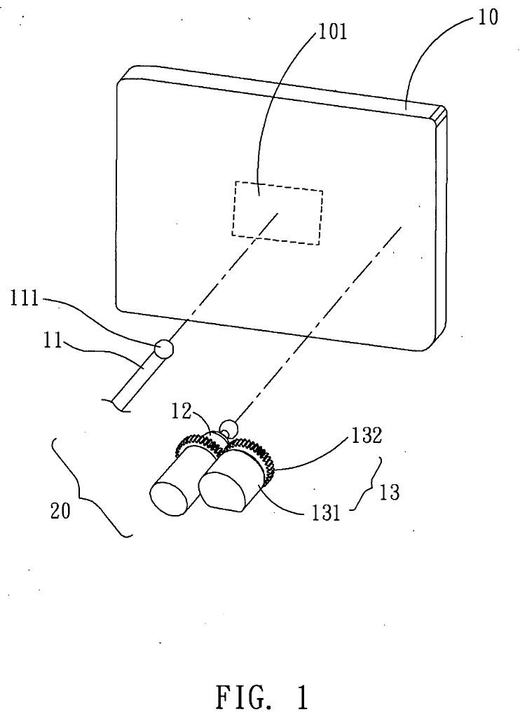

As shown in FIG. 1, a display for a vehicle 1 according to a preferred embodiment of the present invention includes a flat panel 10 and an angle-adjusting mechanism 20 having a holding element 11 and a first active element 12. The angle-adjusting mechanism 20 may further include a first driver 13 for electronically adjusting the flat panel 10. In this embodiment, the flat panel 10 is a preferred liquid crystal display (LCD).

The holding element 11 is connected to the flat panel 10 for supporting the flat panel 10 and has a rotatable portion 111. The rotatable portion 111 can be disposed at one end or any other positions of the holding element 11. In this embodiment, the rotatable portion 111 is disposed at one end of the holding element 11. The holding element 11 is connected to a central region 101 of the flat panel 10. The rotatable portion 111 may be sphere-shaped or gear-shaped. For example, if the rotatable portion 111 is gear-shaped, a sliding seat is correspondingly disposed at the central region 101 of the flat panel 10 and is coupled to the rotatable portion 111 for enabling the holding element 11 to move thereon. The first active element 12 is connected to the flat panel 10, and the first active element 12 and the holding element 11 are disposed at the same side of the flat panel 10.

The first driver 13 is connected to the first active element 12 so as to drive the first active element 12 to allow the flat panel 10 to rotate with respect to the rotatable portion 111 of the holding element 11 and adjust an angle of the flat panel 10. The first active element 12 may be moved forward to push the flat panel 10 or the first active element 12 is moved backward to pull the flat panel 10, whereby adjusting the angle of the flat panel 10.

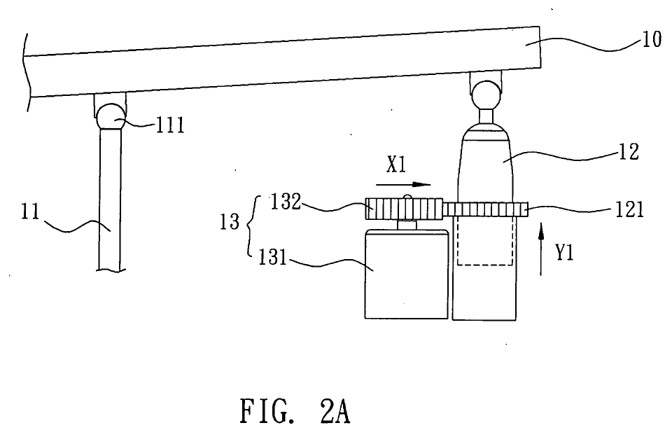

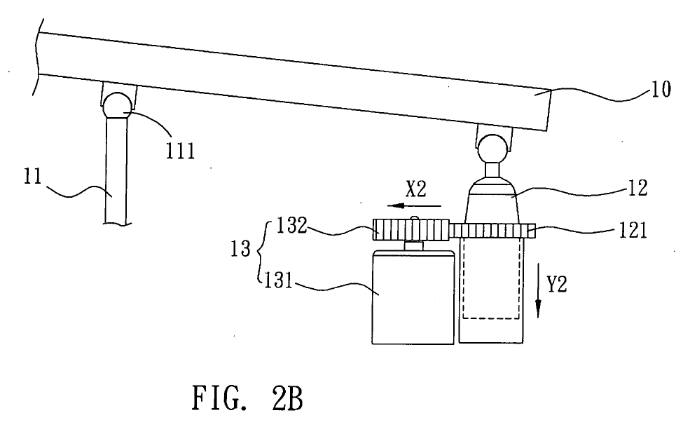

As shown in FIG. 2A, the first driver 13 includes a motor 131 and a first driving element 132 in this embodiment. The first driving element 132 is connected to the motor 131 and the first active element 12. In this embodiment, the first driving element 132 preferably has a gear and the first active element 12 preferably has a gear 121 corresponding to the first driving element 132 so that the first driving element 132 of the first driver 13 can engage with the gear 121 of the first active element 12. When the motor 131 drives the first driving element 132, the gear 121 of the first active element 12 is also driven accordingly. As the results, the first active element 12 may be moved forward or backward to adjust the angle of the flat panel 10. The motor 131 may be a slow speed motor.

If the motor 131 drives the first driving element 132 to rotate in clockwise direction (as arrow X1 shown in FIG. 2A), the first active element 12 is driven to be moved forward along the direction of arrow Y1 in FIG. 2A to push the flat panel 10. If the motor 131 drives the first driving element 132 to rotate in anti-clockwise direction (as arrow X2 shown in FIG. 2B), the first active element 12 is driven to be moved backward along the direction of arrow Y2 in FIG. 2B to pull the flat panel 10. As the results, the angle of the flat panel 10 is adjustable in left-right since the first active element 12 is disposed near a left or right edge of the flat panel 10. Alternatively, the angle of the flat panel 10 can adjustable in up-down since the first active element 12 is disposed near a top or bottom edge of the flat panel 10. Further, the power of push force or pull force of the first active element 12 can be different according to the driver as the requirements of the users.

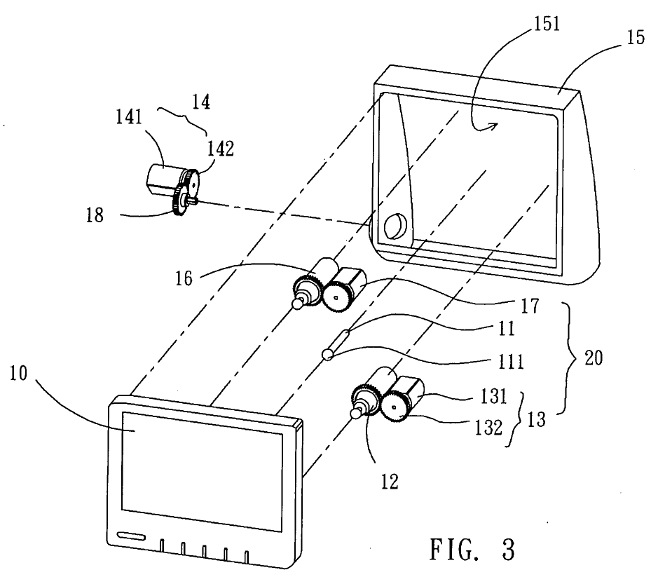

As shown in FIG. 3, the angle-adjusting mechanism 20 of the display for a vehicle 1 according to the present invention may further include a second active element 16 and a second driver 17 for flexibly adjusting the angle of the flat panel 10. The second active element 16 and the second driver 17 have the similar construction and function as the first active element 12 and the first driver 13, respectively. The corresponding descriptions are omitted for concise purpose.

As shown in FIG. 3, the first active element 12 and the first driver 13 are disposed near a left or right edge of the flat panel 10, and the second active element 16 and the second driver 17 are disposed near a top or bottom edge of the flat panel 110. By applying two sets of active element and driver with the holding element 11, the angle of the flat panel 10 is flexibly adjusted in hemisphere.

The display 1 can be adapted to a vehicle in flip-up type, in-dash motorized type, roof-mount type, seat-back type, portable type or other types. In this embodiment, the display 1 is disposed in the car in flip-up type as the example. The display for a vehicle 1 further includes a housing 15, a third driver 14 and a third active element 18. The housing 15 has a space 151 for accommodating and protecting the flat panel 10 and the angle-adjusting mechanism 20 therein. Accompany to design of the housing 15, the display for a vehicle 1 will be more pleasing.

The third active element 18 is connected to the housing 15. The third driver 14 is connected to the third active element 18 so as to allow the housing 15 to rotate with respect to the third active element 18. The third driver 14 may include a motor 141 and a third driving element 142 connected to the motor 141 and the third active element 18. The motor 141 drives the third driving element 142 and the third active element 18 is also driven. Further, the housing 15 is then rotated with respect to the third active element 18, so that the display 1 is opened or closed in the vehicle. The motor 141 may be a slow speed motor.

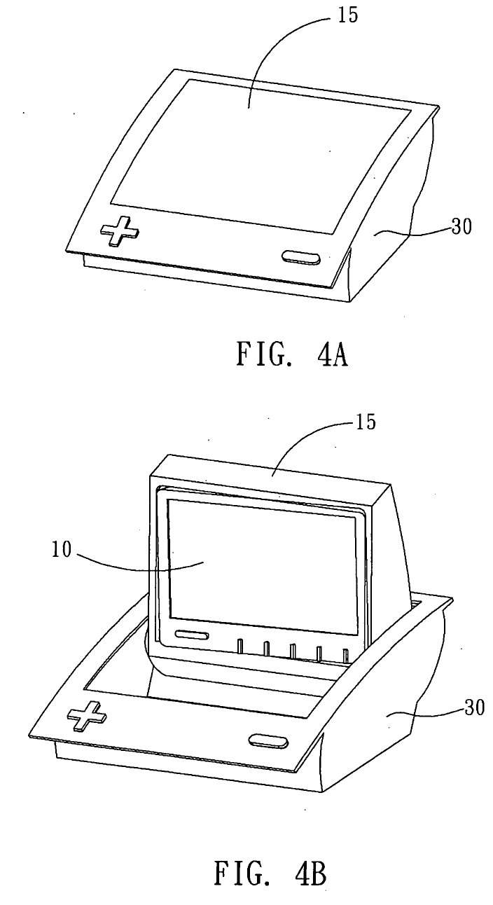

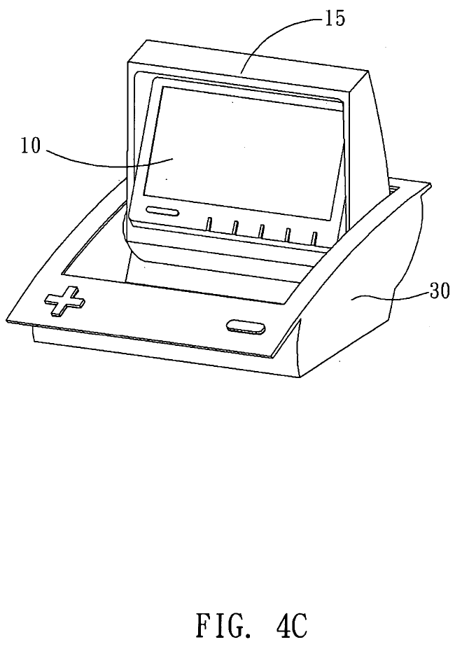

Referring to FIGS. 4A to 4C, when the display 1 is not used, it can be hidden in the central control platform 30 of the vehicle, as shown in FIG. 4A. Also, the display 1 can be opened by using the third driver 14 and the third active element 18 in FIG. 3. The third driver 14 is connected to the third active element 18 so as to allow the housing 15 to rotate with respect to the third active element 18, and thus the display 1 is opened, as shown in FIG. 4B. Further, the angle of the panel 10 is adjustable by the angle-adjusting mechanism 20 in accordance with practical requirements, as shown in FIG. 4C.

In summary, the display for a vehicle of the present invention uses a holding element and a first active element connected to flat panel so as to provide a moving force onto the flat panel. By disposing the first active element near a right or left edge of the flat panel, and disposing the second active element near a top or bottom edge of the flat panel, the flat panel can be pushed or pulled in accordance with practical requirements. As the result, the angle of the flat panel is flexibly adjusted and the display can be clearly viewed.

Although the present invention has been described with reference to specific embodiments, this description is not meant to be construed in a pivoting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A display for a vehicle, comprising:
a flat panel;
a holding element connected to the flat panel and having a rotatable portion; and
a first active element connected to the flat panel.

2. The display according to claim 1, wherein the first active element is moved forward to push the flat panel or the first active element is moved backward to pull the flat panel.

3. The display according to claim 1, further comprising
a first driver connected to the first active element so as to drive the first active element to allow the flat panel to rotate with respect to the rotatable portion of the holding element and adjust an angle of the flat panel.

4. The display according to claim 3, wherein the first driver comprises a motor and at least one first driving element connected to the motor and the first active element.

5. A display for a vehicle, comprising:
a flat panel; and
an angle-adjusting mechanism connected to the flat panel for flexibly adjusting an angle of the flat panel.

6. The display according to claim 5, wherein the angle-adjusting mechanism comprises:
a first active element connected to the flat panel; and
a first driver connected to the first active element so as to drive the first active element to adjust the angle of the flat panel.

7. The display according to claim 6, wherein the first driver comprises a motor and at least one first driving element connected to the motor and the first active element.

8. The display according to claim 7, wherein the motor is a slow speed motor.

9. The display according to claim 6, wherein the first active element is connected to a central region of the flat panel for providing a moving force onto the flat panel.

10. The display according to claim 9, wherein the first active element is moved forward to push the flat panel or the first active element is moved backward to pull the flat panel.

11. The display according to claim 6, wherein the angle-adjusting mechanism further comprises:
a second active element connected to the flat panel; and
a second driver connected the second active element so as to adjust the angle of the flat panel.

12. The display according to claim 11, wherein the second driver comprises a motor and at least one second driving element connected to the motor and the second active element.

13. The display according to claim 11, wherein the first active element is disposed near a right or left edge of the flat panel, and the second active element is disposed near a top or bottom edge of the flat panel.

14. The display according to claim 11, wherein the second active element is moved forward to push the flat panel or the second active element is moved backward to pull the flat panel.

15. The display according to claim 5, wherein the angle-adjusting mechanism further comprises:
a holding element connected to the central region of the flat panel and having a rotatable portion.

16. The display according to claim 15, wherein the rotatable portion of the holding element is sphere-shaped or gear-shaped.

17. The display according to claim 5, wherein the flat panel is in flip-up type, in-dash motorized type, roof-mount type, seat-back type, portable type or other types.

18. The display according to claim 5, further comprising
a housing having a space for accommodating the flat panel and the angle-adjusting mechanism therein.

19. The display according to claim 18, further comprising
a third active element connected to the housing; and
a third driver connected to the third active element so as to allow the housing to rotate with respect to the third active element.

20. The display according to claim 5, wherein the flat panel further comprises a sliding seat coupled to the rotatable portion for enabling the holding element to move thereon.
